(19) United States
(12) Patent Application Publication
(10) Pub. No.: US 2025/0112499 A1
(43) Pub. Date: Apr. 3, 2025

(54) HIGHLY SCALABLE MULTI-LAYER BURIED-VIA-FREE OPTIMIZED WOVEN COPPER TRACE DESIGN FOR HIGH-POWER EV WIRELESS CHARGING

(71) Applicant: TOYOTA MOTOR ENGINEERING & MANUFACTURING NORTH AMERICA, INC., PLANO, TX (US)

(72) Inventors: YANGHE LIU, Ann Arbor, MI (US); ABHILASH KAMINENI, North Logan, UT (US); HIROSHI UKEGAWA, Plano, TX (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/478,929

(22) Filed: Sep. 29, 2023

(51) Int. Cl. H02J 50/10; H01F 27/28; H02J 7/00

(52) U.S. Cl. CPC H02J 50/10; H01F 27/2804; H02J 7/0042; H01F 2027/2809

(57) ABSTRACT

Devices, systems and methods are provided for an electrical coil, for example, a printed circuit board coil. Examples include a substrate, a plurality of conductor layers that include a plurality of trace segments, and a plurality of interlayer connectors electrically interconnecting the plurality of trace segments of different conductor layers to define one or more traces that wind around the substrate. Each of the one or more traces have a density that is based on spacing between each trace segment of the plurality of trace segments. The density of the one or more traces is varied across the plurality of loops of the coil. An electrical coil is formed of the one or more traces wound into a plurality of loops.

### TECHNICAL FIELD

The present disclosure relates generally to electromagnetic coils, and, more particularly, some embodiments relate to a multilayer printed circuit board electromagnetic coils.

### DESCRIPTION OF RELATED ART

Electromagnetic coils are used in a wide variety of electrical applications in connection with the inductive transfer of power. For example, different forms of electrical coils are used in transformers, inductive power couplings and motors. Conventionally, electrical coils have been formed by wrapping a strand of wire into one or more loops.

The “skin effect,” e.g., distribution of alternating current (AC) within a conductor near within a conductor so that the current density near the surface of the conductor is greater than at its core, causes the effective resistance of a conductor to increase with the frequency of the AC current. Litz wire has been used to reduce the skin effect, particularly in high frequency applications. Litz wire is a type that includes many thin wires, individually coated with an insulating film, and twisted together.

### BRIEF SUMMARY OF THE DISCLOSURE

According to various embodiments of the disclosed technology, systems and methods for managing vehicles to mitigate risk to the vehicles due to anomalous driving behavior are provided.

In accordance with some embodiments, an electrical coil is provided. The electrical coil comprises at least one substrate; a plurality of conductor layers, the conductor layers including a plurality of trace segments; a plurality of interlayer connectors electrically interconnecting the plurality of trace segments of different conductor layers to define one or more traces that wind around the at least one substrate, each one or more traces having a density based on spacing between each trace segment of the plurality of trace segments; and a coil formed of the one or more traces wound into a plurality of loops. The density of the one or more traces is varied across the plurality of loops of the coil.

In another aspect, a wireless charging system is provided. The wireless charging system comprises an electrical coil comprising a coil having a plurality of turns of a trace bundle; and the trace bundle comprises a plurality of traces formed from a plurality of trace segments electrically connected by a plurality of interlayer connectors. Each of the plurality of traces comprises a density of trace segments, and the density of the plurality of traces is varied across the plurality of turns of the coil.

In another aspect, a method for fabricating an electrical coil is provided. The method comprises generating at least one route design corresponding to a trace based on one or more design parameters and repeating the at least one route design for a plurality of traces to form a trace bundle. The plurality of traces are spaced based on a gap width included in the design parameters. The method also includes generating a coil design from the trace bundle, and fabricating the electrical coil from the coil design.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIGS. 1A-1C are view of an example printed circuit board (PCB) coil in accordance with embodiments of the present disclosure.

FIGS. 2A-2C depict examples of various trace densities in accordance with embodiments disclosed herein.

FIGS. 3A-3C illustrates an example four layer implementation of PCB coil in accordance with an embodiment of the present disclosure.

FIGS. 4A-4C illustrates an example six layer implementation of PCB coil in accordance with an embodiment of the present disclosure.

FIG. 5 is a schematic block diagram of an example PCB coil having varying coil density in accordance with embodiments of the present disclosure.

FIGS. 6A and 6B illustrate examples of interlayer connectors in accordance with embodiments of the present disclosure.

FIGS. 7A through 7D-2 depict a flow diagram of an example method of manufacturing a PCB coil in accordance with embodiments of the present disclosure.

FIG. 8 is an example of a mulita-route design in accordance with an embodiment of the present disclosure.

FIG. 9 illustrates example of corner connections in fabricating a PCB coil in accordance with embodiments of the present disclosure.

FIG. 10 shows changing trend of Q-factor for various PCB coils in accordance with embodiments of the present disclosure.

FIG. 11 shows a typical wireless charging system.

FIG. 12 is an example computing component that may be used to implement various features of embodiments described in the present disclosure.

The figures are not exhaustive and do not limit the present disclosure to the precise form disclosed.

### DETAILED DESCRIPTION

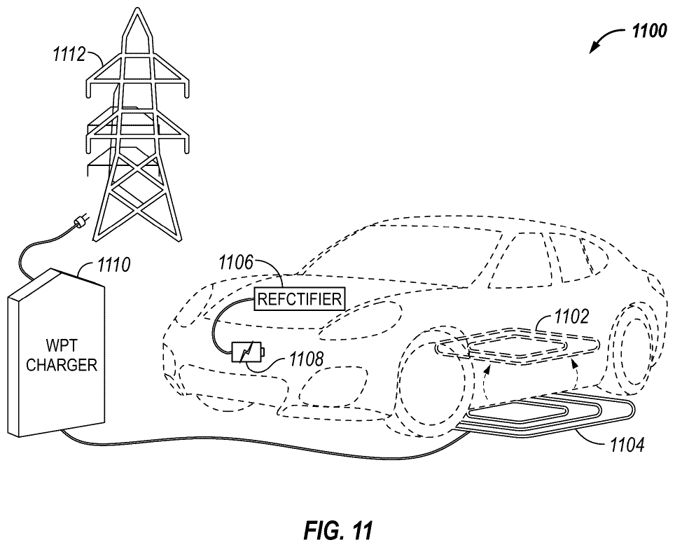

As alluded to above, electromagnetic coils are used in a variety of electrical applications in connection with the inductive transfer of power, such as wireless power transfer for power exchange in electrical vehicle applications. Wireless power transfer has been widely researched and developed due to its ease of use and elimination of manual power plugging. This technology has gained attention from not only the low-power consumer electronics industry but also the high-power electric vehicle (EV) wireless charging community. A typical wireless charging system 1100 is shown in FIG. 11, which includes an electric vehicle 1102 having a receiver coil 1104 installed on a chassis of the electric vehicle 1102. Wireless power transfer utilizes a magnetic field to transfer power wirelessly from an energized transmitter pad (or ground-based infrastructure) 1106, having a transmitter coil 1112, to the receiver coil 1104. Conventionally, the receiver and transmitter coils have dimensions of 350 mm×350 mm with an air space of around which the coil turns. The air space may be, for example, 150 mm-250 mm for a passenger vehicle wireless charging. After the receiver coil absorbs the magnetic field in the form of AC power, a rectifier 1108 converts the power into DC current to charge the vehicle main battery 1110. The power transfer efficiency relies on many factors such as, but not limited to, air gap between the receiver coil 1104 and the transmitter coil 1112, alignment between the coils, coil compatibility (e.g., matching of resonance frequencies), etc.

As discussed above, performance of the power transfer of a wireless charging system, such as that shown in FIG. 11, can be negatively impacted by the skin effect that causes an increase in effective resistance within the coils. This increased effective resistance can result in temperature fluctuations and reduced power coupling between the coils. To reduce the skin effect, electromagnetic coils used in high frequency applications are often wound from Litz wire.

Litz wire is a type of wire that includes many wires, individually coated with an insulating film, and twisted together. The individual wires are combined and twisted following a prescribed pattern often involving several levels of twisting (groups of twisted wires twisted together, etc.). Due to the combination of separate smaller wires, the conductor formed from a Litz wire can have a greater surface area than a conventional solid conductor, thereby reducing the skin effect. As a result of this and the twisting configuration, the power losses associated with Litz wire coils can be substantially lower than conventional solid wire coils when used in high-frequency applications.

However, conventional Litz wires suffer from a number of disadvantages. For example, the resistance of a Litz wire coil is higher than theoretically achievable because individual strands are round and coated with an insulator so that the overall cross-section includes a substantial amount of non-conducting elements, such as air and insulator. Additionally, the conductors are thermally insulated and lack a heat-carrying path aside from the conductors themselves. As a result, power handling by a Litz wire may be need to be reduced to account for thermal considerations. Furthermore, the manufacturing process for Litz wire and Litz wire coils is expensive and intricate, requiring special, costly equipment. For example, in wireless charging coil applications, a Litz wire coil can include at least 800 individual strands that are twisted together to collectively form the conductor, which then needs to be wound to form the coil itself. Further, a Litz wire may be bulkier than desired for some applications because of packing density from wire to wire and the space occupied by the insulation between strands.

To address these issues, among others, a coil can be formed directly into a printed circuit board (PCB), for example, by forming the coil on the circuit board. While some prior art approaches have attempted to form coils in PCB, these conventional printed circuit board coils suffer from certain short comings and difficulties. For example, some conventional PCB coils rely on non-standard PCB manufacturing techniques, such as using blind or buried vias to connect layers of a PCB. These vias require expensive and non-standard manufacturing techniques that complicate the manufacturing of and increase costs associated with the conventional PCB coils. Additionally, the conventional PCB coils are not scalable to different size coils, power levels, etc. This may be due to the design. For example, when designing a planar coil on PCB for wireless charging, the size and power level requirements are defined and the design is made to meet these parameters. Thus, the coil designed may be specific for meeting these requirements, such as physical constraints, inductance, resonance and magnetic field distribution. Furthermore, conventional PCB coils can suffer from uneven distribution of induced current and inductance within the PCB coil. Further, stacked PCB coils can introduce unwanted parasitic capacitance due to some of the coils receiving more of the magnetic field than others. Ultimately, this can result in higher resistance leading to thermal considerations as power requirements increase.

Accordingly, embodiments disclosed herein provide for methods and devices that replaces conventional Litz wire and conventional PCB coils with a scalable PCB coil for fitting various charging applications with different power levels, size requirements, etc. The embodiments disclosed herein provide this scalability while maintaining high power transfer efficiency and high power handling. For example, embodiments disclosed herein begin with a unit cell design, which can be repeated in multiple layers and scaled to any number of planar sizes.

In some embodiments, a PCB coil is provided that includes a plurality of conductor layers and one or more substrate or insulator layers. The conductor layers may be provided as any conductive material known in the art, for example but not limited to, copper. Each one or more insulator layers is provided between two conductor layers. Thus, the number of insulator layers may be one less than the number of conductor layers. Each conductor layer can comprise a plurality of trace segments formed therein. A plurality of interlayer connectors are fabricated that interconnect trace segments of different conductor layers to form one or more traces. These traces may function similar to a strand of wire in a conventional Litz wire. The interlayer connectors may be provided as through vias formed at an edge of the insulator layer, with the trace segments extending across the insulator layer from one through via on one edge to another through via on another edge. As such, the trace winds or is twisted around the insulating layer. The one or more traces collectively provide for a trace bundle that can then be formed into a coil structure to provide the PCB coil.

Each trace may comprise a trace density based on spacing between each trace segment and spacing between each interlayer connector forming the trace. For example, a smaller spacing between trace segments and/or interlayer connectors translates to higher density (e.g., more trace segments per unit of distance) and larger spacing translates to a lower density. In some embodiments, the density of the traces can be varied as a function of location along the PCB coil. By varying the trace density, current propagating in the coil can be controlled which can address thermal considerations. For example, a higher density of traces can be formed to reduce thermal properties, such as temperatures, which permit larger currents through the coil. A lower density can be used where thermal considerations are less prominent. For example, if thermal considerations are of less prominent, a lower density can carry enough power with higher temperature but reduce total weight and material cost.

A nonlimiting advantage of the embodiment disclosed herein is that it can be extended to any size or number of PCB layers as needed for any desired application. For example, power level and physical installation space can vary significantly for different grades of vehicles (e.g., commercial vehicles compared to consumer vehicles, hybrid vehicles compared to fully electric vehicles, a car compared to a truck, etc.). Conventional PCB coils and Litz wires require a special design of the receiver coil on the vehicle, for example, based on design space, gap, power level, thermal requirements, and electrical requirements. Whereas, embodiments disclosed herein provide for scalability through a base trace design pattern that can be repeated at design stages to form trace bundles and extended to multiple PCB layers, as well as varied in physical size, without redesigning the base trace pattern. This base trace design pattern (e.g., the unit cell), which defines the trace segments and interlayer connectors forming a single trace route, can be provided according to the power and space needs of a given application and then repeated to provide multiple traces. Parameters, such as trace segment lengths, spacings, etc., that define the base trace pattern can adjusted as desired without requiring a redesign of the base pattern. Thus, embodiments disclosed herein can be implemented for any n space, gap, power level, thermal requirements, and electrical requirements.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

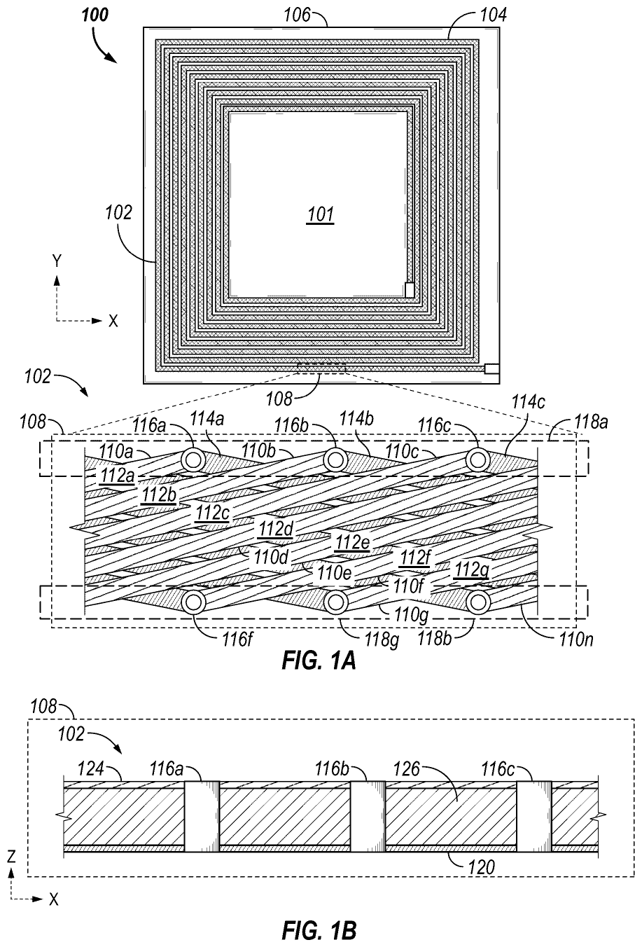

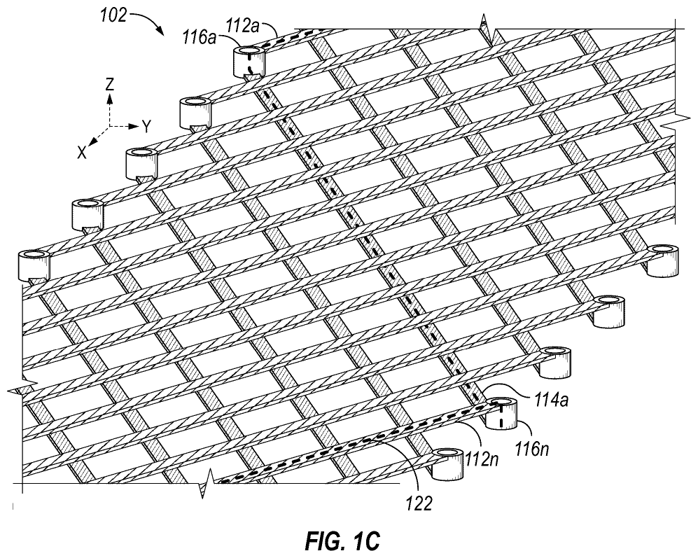

FIG. 1A is a top down view of an example PCB coil 100 in accordance with embodiments of the present disclosure. The PCB coil 100 includes a trace bundle 102 wound through a plurality of turns or loops around air space 101 to form a coil 104 on a substrate 106. FIG. 1B illustrates a side view of a portion the trace bundle 102 and FIG. 1C depicts a perspective view of a portion of the trace bundle 102 with the substrate 106 removed for illustrative purposes only to assist with ease of understanding and as relative orientation between parts.

FIG. 1A includes zoomed in view 108 which depicts an enlargement of a portion of trace bundle 102. As shown in the view 108, the trace bundle 102 comprises a plurality of individual trace (or trace strands) 110a-110n (collectively referred to herein as traces 110) that are twisted or wound around portions of substrate 106 to form the trace bundle 102. The portions of substrate 106 around which traces 110 are wound can be considered insulating layers 126, which are shown in FIG. 1B. In this example, six traces 110 are shown, but any number of traces may be provided as desired. The traces may be formed of a conductor, such as, but not limited to, copper.

Each trace 110 is formed from trace segments 112a-112n (collectively referred to herein as trace segments 112) and trace segments 114a-114n (collectively referred to herein as trace segments 114) that are connected by interlayer connectors 116a-116n (collectively referred to herein as interlayer connectors 116). As an illustrative example, trace 110a is shown comprising a trace segment 112a that is connected to a trace segment 114a by an interlayer connector 116a. This pattern of connection is repeated along the length of the trace bundle 102. The interlayer connectors 116 may be provided at outer perimeters or edge regions 118a and 118b of trace bundle 102, with the trace segments 112 and 114 extending linearly across the trace bundle 102 from an interlayer connectors 116 to another interlayer connectors 116 on edge region 118b. Thus, each trace segment 112 can be substantially parallel to other trace segments 112 and each trace segment 114 can be substantially parallel to other trace segments 114. Both trace segments extend linearly in the X-axis direction, but in opposite directions along the Y-axis, in this example.

As shown in FIG. 1B, trace segments 112 can be formed in a conductor layer 124 on a first (e.g., upper) side of insulating layer 126 and trace segments 114 can be in from a conductor layer 120 on a second or opposite (e.g., bottom) side of insulating layer 126. Interlayer connectors 116 interconnect one of trace segments 112 to one of trace segments 114. Thus, each trace segment of a given layer can be substantially parallel to other trace segments of the same layer. The interlayer connectors 116 can be formed on the outer perimeter or edge regions 118a and 118b of insulating layer 126. Trace segments and interlayer connectors can be formed using any PCB manufacturing techniques as known in the art. Reference to upper and bottom side are provided as examples to assist with ease of understanding and as relative orientation between layers. Reference to upper and bottom are not intended to limit the disclosure to vertical orientations.

Each trace 110 follows a trace route that winds around the insulating layer 126. FIG. 1C depicts an example trace route 122 for trace 110a, through which trace segment 112a is connected to trace segment 114a via interlayer connector 116a and trace segment 114a is connected to trace segment 112n via interlayer connector 116n. In this example, each trace segment extends linearly from one interlayer connector 116 to the next, without deviation from the trace route. As a result, in the example shown in FIG. 1C, trace 110 is wound around an insulating layer 126 forming a generally rectangular helical pattern having rotations or turns in a first direction (e.g., Z-axis direction) and translations along a plane perpendicular to the first direction (e.g., X-Y plane in this example).

In operation, an alternating current (AC) can be applied to the trace bundle 102, which will flow in substantially equal amounts in each of the individual traces 110. Because the current may be distributed uniformly across the strands, the AC resistance may be reduced. In embodiments, system trade-offs such as number and size of individual traces, numbers of layers of the PCB coil, connection complexities, board space, and the like, may be considered to determine the optimum routing pattern and design.

In embodiments, trace bundle 102 can be reproducible and scalable through repeated routing of multiple trace 110a-110n. For example, the trace bundle 102 can be formed by repeating the trace route 122 for each trace 110 and providing a spacing or gap between each adjacent trace 110. By repeating the trace route 122 with a different starting point spaced apart from a neighboring trace 110, a plurality of traces 110 can be formed having a common shape with a spacing therebetween in the X-Y plane. As a result, the trace bundle 102 can comprise a number of helical patterns, as shown in FIG. 1C, twisted around insulating layer 126. Scalability can be achieved by altering starting points, spacings, and dimensions of the various components to form traces of desired dimensions.

While the examples of FIGS. 1A-1C illustrate a portion of trace bundle 102 that extends along the X-axis direction, the coil 104 comprises similar structural configurations for other positions of trace bundle 102 of other orientations. For example, a length of trace bundle 102 that extends in the Y-axis direction (e.g., right or left sides of PCB coil 100 in FIG. 1A) would have a similar structure as that shown FIGS. 1A-1C, but with an orientation rotated according to the changed orientation of the length of trace bundle 102.

Furthermore, with reference to the example axes shown in FIGS. 1A-1C, the axes are provided as examples to assist with ease of understanding and as relative orientation between parts. The axes are not intended to limit the disclosure to horizontal or vertical directions.

In embodiments, design parameters of a trace bundle 102 can varied to achieve differing trace densities. Trace density may be controlled based on spacing between routes of each traces 110a-110n and by the patterned geometry of the trace bundle 102. The location of the interlayer connectors 116 on the outer perimeter can enable scaling and replication of the pattern as well as tight and uniform individual trace placement and density since the interlayer connectors are not used within the trace segments themselves, potentially disrupting uniformity of the pattern and the density of the pattern. For example, spacing between adjacent interlayer connectors 116 can be adjusted which translates to an adjustment of the spacing between the connected trace segments.

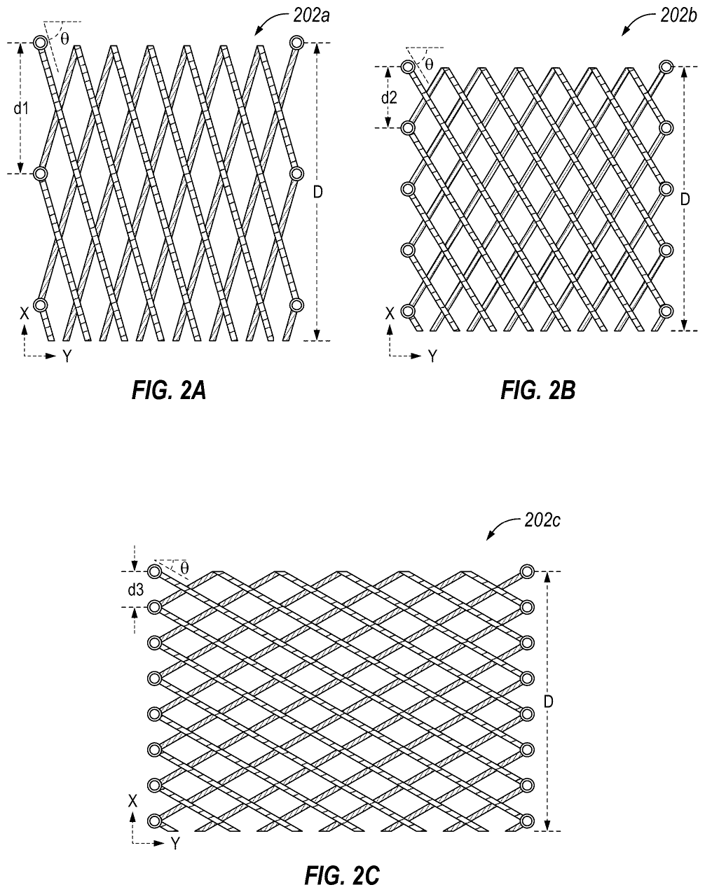

FIGS. 2A-2C depict examples of different trace densities in accordance with embodiments disclosed herein. FIGS. 2A-2C show portions of trace bundles 202a-202c, respectively, each of which may be substantially the same as trace bundle 102 of FIGS. 1A-1C, except that the trace density is differed between each trace bundle. FIG. 2A shows a length D of trace bundle 202a having a first trace density, FIG. 2B shows the length D of trace bundle 202b having a second trace density that is higher than the first trace density, and FIG. 2C shows the length D of trace bundle 202c having a third trace density that is higher than the second trace density (e.g., increased number of trace segments per unit length).

In each figure, the length of each portion of the respective trace bundle is the same, denoted as distance D, but the distance between adjacent interlayer connectors is changed. For example, FIG. 2A shows a distance of d1 between adjacent interlayer connectors, while FIG. 2B shows a distance of d2, which is smaller than d1. Similarly, FIG. 2C show s distance of d3 between adjacent interlayer connectors, which is smaller than d2. As a result, the angle θ formed between trace segments and the Y-axis decreases as the distance between interlayer connectors decreases. The spacing between trace segments also decreases with decreased distance between interlayer connectors. Thus, an increased number of trace segments, and therefore traces, are present within distance D of the trace bundle.

Returning to FIGS. 1A-1C, coil 104 is shown as an example of a two-layer PCB coil, having two conductors layers each having a plurality of trace segments that are interconnected by the interlayer connectors to define traces 110. However, embodiments disclosed herein can be extended to more than two layers, for example, a four-layer PCB coil, six-layer PCB coil, eight layers, to as many layers as desired. In each case, an insulating layer is provided between two neighboring conductor layers. Thus, the number of insulating layers is N-1, where N is the number of conductor layers. Through the multi-layer structure, a trace bundle (such as trace bundle 102) can include a number of sub-bundles. Each sub-bundle may be defined by a pair of conductor layers having trace segments formed thereon and interconnected by interlayer connectors forming traces that wind around one or more insulating layers. In embodiments, providing additional layers may function to increase trace density as there more layers means that more traces are present with a length of the coil 104. This approach to varying the trace density can be used alone or in tandem with the adjusting of spacing between interlayer connectors discussed above.

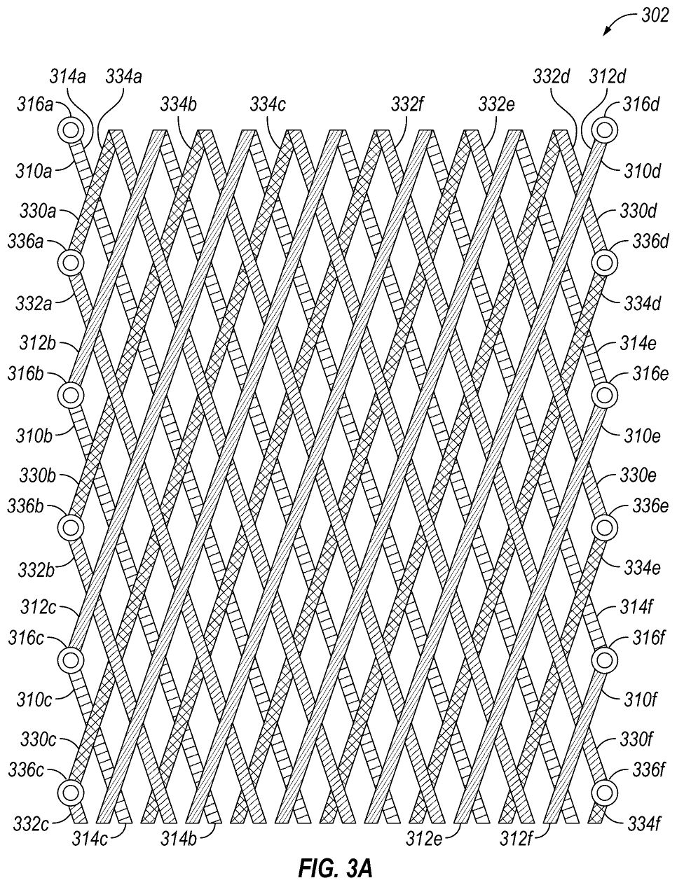

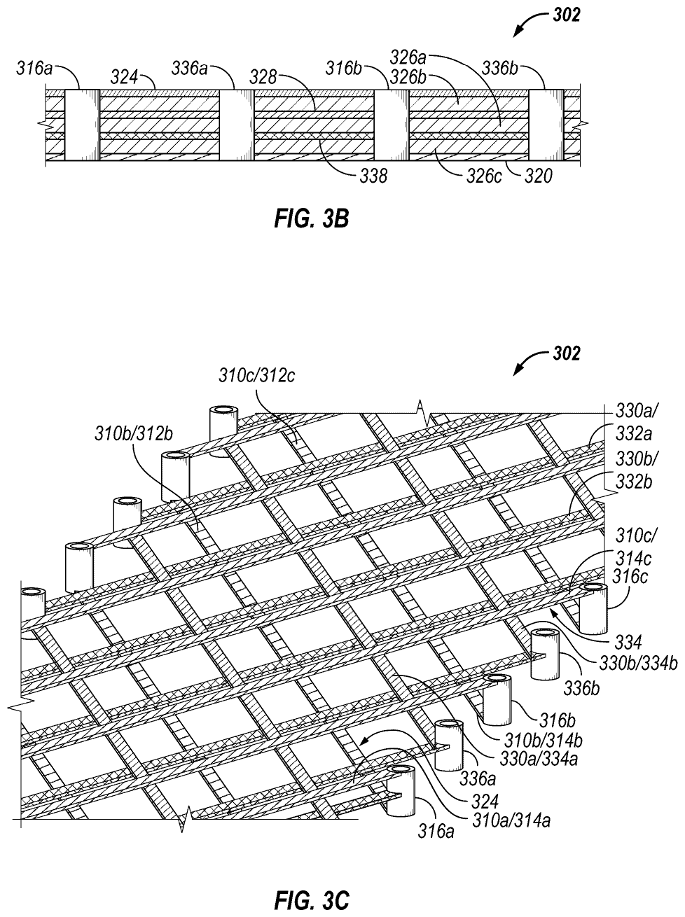

FIGS. 3A-3C illustrates an example four layer trace bundle 302 in accordance with an embodiment of the present disclosure. Trace bundle 302 may be included as part of a four layer PCB coil. FIG. 3A is a top down view of a portion the trace bundle 302, FIG. 3B is a side view of a portion the trace bundle 302, and FIG. 3C is a perspective view of a portion of the trace bundle 302 with the insulating layers removed for illustrative purposes only to assist with ease of understanding and as relative orientation between parts.

In the example of FIGS. 3A=3C, trace bundle 302 comprises a first plurality of traces 310 and a second plurality of traces 330 that are twisted or wound around one or more of insulating layers 326a-326c to form the trace bundle 302. In this example, traces 310 may provide a first sub-bundle and traces 330 provide a second sub-bundle. In the example shown in FIG. 3A, eight traces 310 and eight traces 330 are shown, but any number of traces may be provided as desired. The traces may be formed of a conductor, such as, but not limited to, copper.

Each trace 310 is formed from trace segments 312a-312n (collectively referred to herein as trace segments 312) and trace segments 314a-314n (collectively referred to herein as trace segments 314) that are connected by interlayer connectors 316a-316n (collectively referred to herein as interlayer connectors 316).

Each trace 330 is formed from trace segments 332a-332n (collectively referred to herein as trace segments 332) and trace segments 334a-334n (collectively referred to herein as trace segments 334) that are connected by interlayer connectors 336a-336n (collectively referred to herein as interlayer connectors 336).

As shown in FIG. 3B, trace segments 312 can be formed in a conductor layer 324 on a first (e.g., upper) side of insulating layer 326a and trace segments 314 can be formed in a conductor layer 320 on a bottom side of insulating layer 326c. Further, trace segments 332 can be formed in a conductor layer 328 between a bottom side of insulating layer 326a and a first (e.g., upper) side of insulating layer 326b and trace segments 334 can be formed in a conductor layer 338 between a bottom side of insulating layer 326b and an upper side of insulating layer 326c. Interlayer connectors 336 interconnect one of trace segments 312 to one of trace segments 314, while interlayer connectors 336 interconnect one of trace segments 332 to one of trace segments 334.

Thus, each trace 310 and 330 follows a trace route that winds around one or more of insulating layers 326a-326c. For example, each trace 310 winds around each of insulating layer 326a-326c, each trace 330 winds around insulating layer 326b.

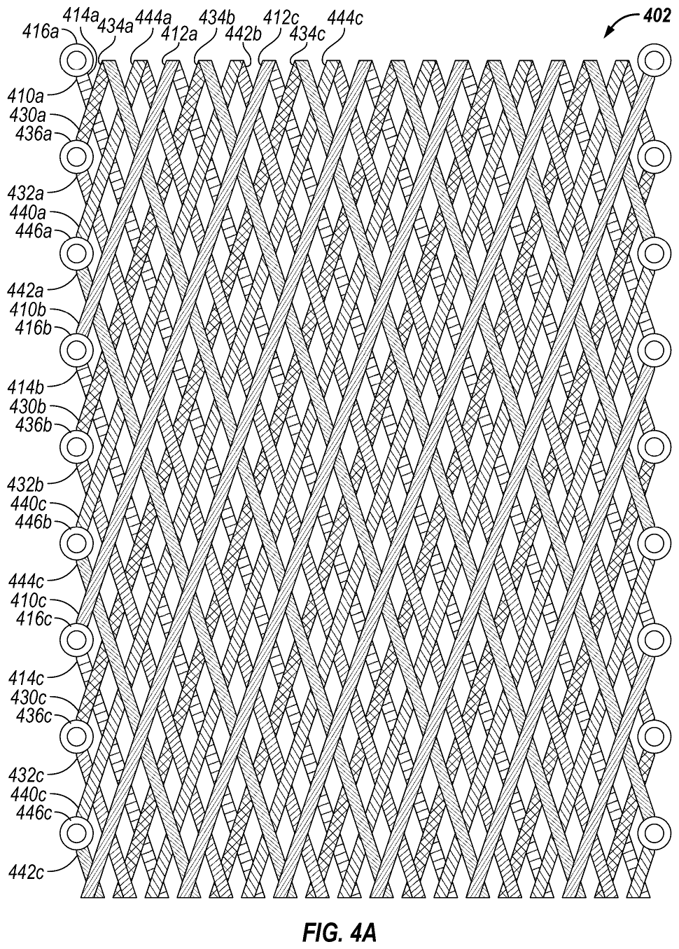

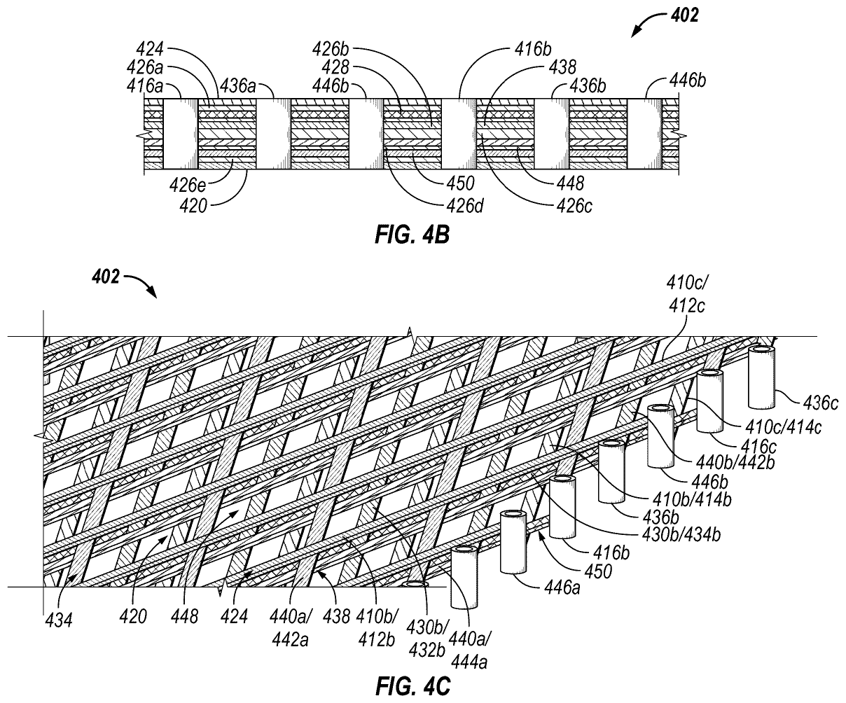

FIGS. 4A-4C illustrates an example six layer trace bundle 402 in accordance with an embodiment of the present disclosure. Trace bundle 402 may be included as part of a six layer PCB coil. FIG. 4A is a top down view of a portion the trace bundle 402, FIG. 4B is a side view of a portion the trace bundle 402, and FIG. 4C is a perspective view of a portion of the trace bundle 402 with the insulating layers removed for illustrative purposes only to assist with ease of understanding and as relative orientation between parts.

In the example of trace bundle 402, trace bundle 402 comprises a first plurality of traces 410, a second plurality of traces 430, and a third plurality of traces 440 that are twisted or wound around one or more of insulating layers 426a-426e to form the trace bundle 402. Traces 410 may provide a first sub-bundle, traces 430 may provide a second sub-bundle, and traces 440 may provide a third sub-bundle. Each trace 410 is formed from trace segments 412a-412n (collectively referred to herein as trace segments 412) and trace segments 414a-414n (collectively referred to herein as trace segments 414) that are connected by interlayer connectors 416a-416n (collectively referred to herein as interlayer connectors 416). Each trace 430 is formed from trace segments 432a-432n (collectively referred to herein as trace segments 432) and trace segments 434a-434n (collectively referred to herein as trace segments 434) that are connected by interlayer connectors 436a-436n (collectively referred to herein as interlayer connectors 436). Each trace 440 is formed from trace segments 442a-442n (collectively referred to herein as trace segments 442) and trace segments 444a-444n (collectively referred to herein as trace segments 444) that are connected by interlayer connectors 446a-446n (collectively referred to herein as interlayer connectors 446).

As shown in FIG. 4B, trace segments 412 can be formed in a conductor layer 424 on an upper side of insulating layer 426a and trace segments 414 can be formed in a conductor layer 420 on a bottom side of insulating layer 426e. Further, trace segments 432 can be formed in a conductor layer 428 between a bottom side of insulating layer 426a and an upper side of insulating layer 426b and trace segments 434 can be formed in a conductor layer 438 between a bottom side of insulating layer 426b and an upper side of insulating layer 426c. Additionally, trace segments 442 can be formed in a conductor layer 448 between a bottom side of insulating layer 426c and an upper side of insulating layer 426d and trace segments 444 can be formed in a conductor layer 450 between a bottom side of insulating layer 426d and an upper side of insulating layer 426e. Interlayer connectors 416 interconnect one of trace segments 412 to one of trace segments 414, while interlayer connectors 436 interconnect one of trace segments 432 to one of trace segments 434 and interlayer connectors 446 interconnect one of trace segments 442 to one of trace segments 444.

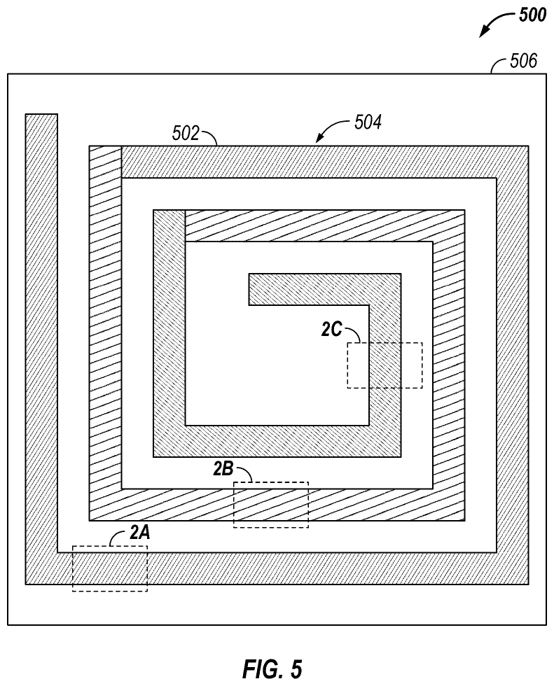

FIG. 5 is a schematic block diagram of an example PCB coil 500 having varying coil density along the length of the PCB coil 500 in accordance with embodiments of the present disclosure.

The PCB coil 500 includes a trace bundle 502 wound through a plurality of turns or loops to form a coil 504 on a substrate 506. The trace bundle 502, coil 504, and substrate 506 may be substantially similar to trace bundle 102, coil 104, and substrate 106 as described in connection with FIGS. 1A-1C. Thus, trace bundle 502 comprises a plurality of individual traces (e.g., traces 110) that are twisted or wound around portions of substrate 506, considered insulating layers (not shown in FIG. 5 for easy of understanding) to form the trace bundle 502. Each trace is formed from trace segments (e.g., trace segments 112 and 114) that are connected by interlayer connectors (e.g., interlayer connectors 116).

FIG. 5 illustrates a plurality of locations 508a-508c along the coil 504 and a zoomed in view of a portion of trace bundle 502 at each location 508a-508c. In this example, location 508c is closer to a center of the trace bundle 502 than location 508b and location 508a, while location 508a is the farthest from the center (e.g., an outer end of the coil). As can be seen from FIG. 5, the trace density of trace bundle 502 at each location 508a-508c differs relative to the other locations 508a-508c. For example, the trace density of trace bundle 502 at location 508a is illustratively shown as trace bundle 202a having the trace density described in connection with FIG. 2A, the trace density of trace bundle 502 at location 508b is illustratively shown as trace bundle 202b having trace density described in connection with FIG. 2B, the trace density of trace bundle 502 at location 508b is illustratively shown as trace bundle 202c having the trace density described in connection with FIG. 2C. That is, for example, the spacing between adjacent interlayer connectors is reduced as one progresses from location 508a to location 508c, thus increasing trace density at each location.

As described above, by varying the trace density, current propagating in the coil can be controlled which can address thermal considerations. For example, at inner turns of a PCB coil 504 (e.g., locations 508c), thermal considerations can dominate as the inner turns become hotter than outer turns (e.g., location 508a) due to non-uniform current distribution. A higher density of traces can be provided at these inner locations to permit larger currents through those locations of the PCB coil 504, which lowers temperature and improves overall performance. A lower density of trace segments can be utilized where thermal considerations are less prominent (e.g., location 508a), which allows for less conductive material to be used in manufacturing thus lower manufacturing costs. Thus, PCB coil 500 can be provided to address varying current and thermal demands across the PCB coil by varying the density of traces across the length of the PCB coil 500.

In some embodiments, the change in trace density need not be at a corner or turn of the coil 504, and may instead be at any point along a vertical and/or horizontal length of the coil. That is, for example, a change in trace density may occur at any location along the length of the coil 504 according to a desired implementation.

While three different locations and trace densities are shown in this example, the embodiments disclosed herein are not intended to be limited to three. Any number of changes in trace density may be provided along the length of coil 504.

Additionally, while the example shown in FIG. 5 leverages spacing between interlayer connectors 516 to adjust the trace density, embodiments disclosed herein are not so limited. For example, trace density may be adjusted through adding or remove sub-bundles to the trace bundle 502. As an illustrative example, a two layer trace bundle (e.g., trace bundle 102) may be used at location 508a, a four layer trace bundle (e.g., trace bundle 302) at location 508b, and a six layer trace bundle (e.g., trace bundle 402) at location 508c. In this case, at each transition, a single trace from a lower numbered layer trace bundle may be connected to one or more traces of a larger numbered layer trace bundle (e.g., transitioning from trace bundle 102 to trace bundle 302 may require a single trace 110 to connect to two traces 310 or to two sub-bundles, such as a trace 310 and a trace 330).

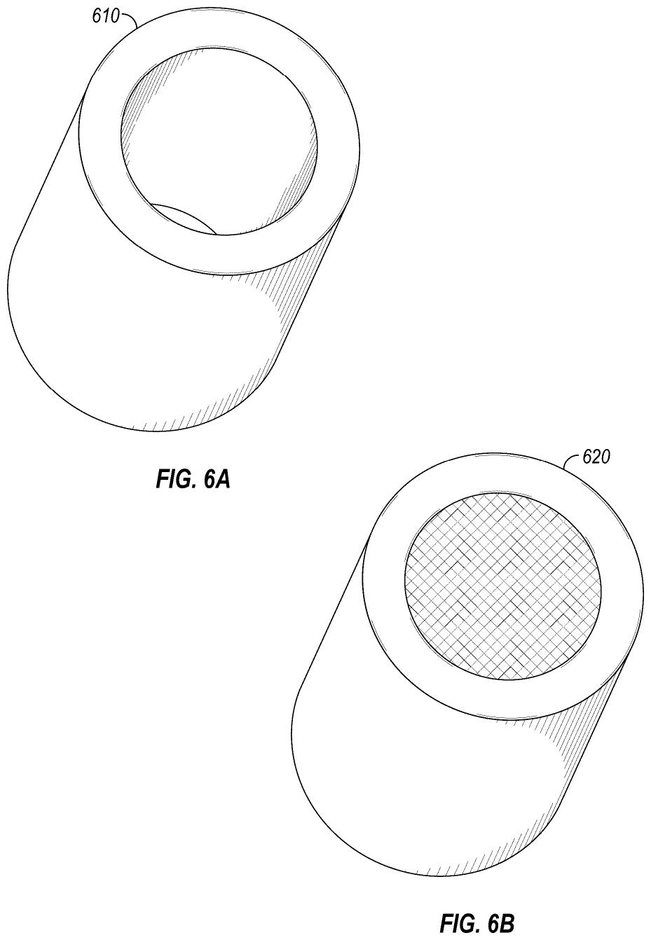

FIGS. 6A and 6B illustrate examples of interlayer connectors in accordance with embodiments of the present disclosure. FIGS. 6A and 6B show interlayer connectors 610 and 620, respectively, which can be implemented as any interlayer connectors disclosed herein. FIG. 6A depicts interlayer connectors 610 as a hollow through via and FIG. 6B depicts interlayer connectors 620 as a filled through via.

To increase reliability and conductivity of the embodiments disclosed herein, filled through vias of FIG. 6B can be used. The PCB coils disclosed herein generally operate under high power conditions which can lead to temperature changes. Thin copper-plated through vias could be fragile under thermal cycling because of thermal expansion. Thus, in high power applications, filling the through via can be utilized to enhance the strength and also reduce overall resistance in a connected trace for lower power loss. The filled through via of FIG. 6B can be implemented by electroless plating when the through via size is small. As another example, the filling can be done through a conductive paster curing process. After the through vias are filled, a conductive paste, such as, but not limited to, copper paste or silver paste can be applied followed by a high temperature curing for solidification.

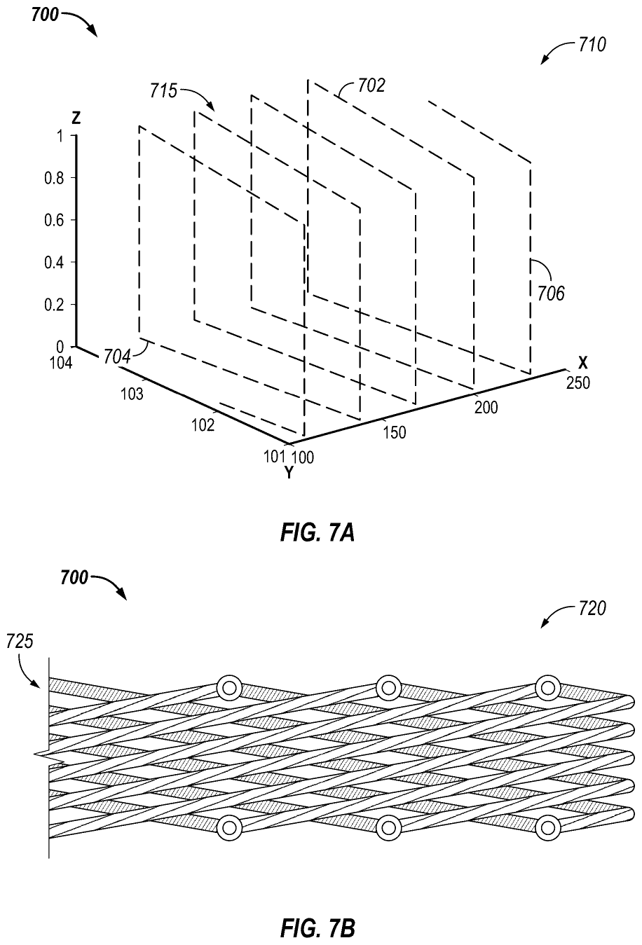

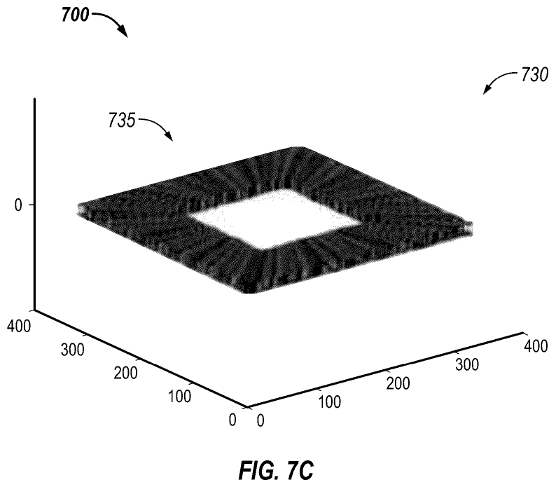

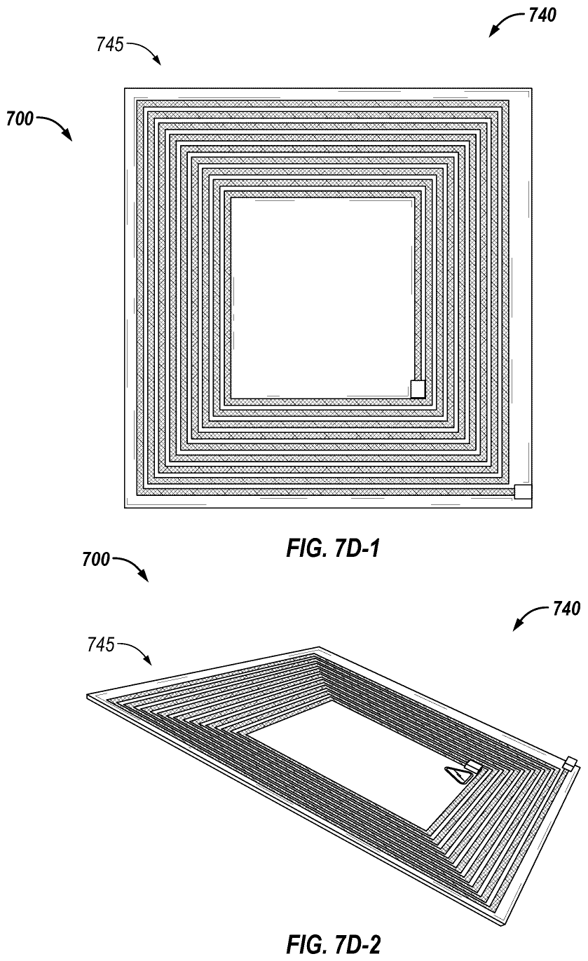

FIGS. 7A through 7D-2 depict a flow of an example method 700 for manufacturing a PCB coil in accordance with embodiments of the present disclosure. The method 700 provides for generating repeatable trace routes, such as trace route 122 describe above, from which traces and trace bundles can be fabricated that are both reproducible and scalable with minimal redesign.

At operation 710, a route design 715 is generated for a signal trace of a trace bundle. This route design 715 may represent a unit cell. In some embodiments, route design 715 can be generated using a trace design tool, such as MATLAB® or other trace design system. For example, design parameters can be entered into the trace design system that executes code to generate the route design 715 according the design parameters. The design parameters may include, for example by not limited to, a desired orientation, starting point, thickness of coil, width of coil, and length of coil. Consideration of system trade-offs may be made determine the optimum routing pattern and design, such as number and size of individual traces, numbers of layers of the PCB, connection complexities, board space, and the like. From these inputs, the trace design system can automatically generate the route design 715. Thus, the route design can be repeatable and scalable as desired.

Route design 715 is an example of design from which a single trace (e.g., trace 110) can be fabricated. For example, route design 715 comprises segment designs 702 and 704 which are generated at a distance apart from each other. The segment designs 702 and 704 may correspond to a design for each trace segment of the trace. For example, segment deigns 702 may correspond to trace segments 112 of FIGS. 1A-1C and segment deigns 704 may correspond to trace segments 114. The distance between segment deigns 702 and 704 may correspond to the thickness of an insulating layer (e.g., insulating layer 126) on which the trace segments are to be formed. Route design 715 also includes vertical lines or connector designs 706 which can correspond to locations of the interlayer connectors (e.g., interlayer connectors 116).

While route design 715 is shown having certain dimensions, these dimensions are provided as examples for illustrative purposes. As noted above, design parameters may be entered according to a desired implementation which the trace design system uses to generate the optimal route design 715.

Once generated, route design 715 can be used to generate a bundle design 725 at operation 720. For example, the trace design system can take design parameters of the unit cell route design 715 and repeat the route design 715 at different starting points so to generate a bundle design 725. Example design parameters for operation 720 include, but are not limited to, a minimum trace width and a minimum gap distance between each trace adjacent trace. The minimum trace width defines the width of each trace segment and interlayer connectors that forms the trace, with the route design 715 at a mid-point of the minimum trace width. In this example, bundle design 725 is shown as an example corresponding to the trace bundle 102 of FIG. 1A, in which multiple route design 715 are generated with spacing therebetween to provide for a number of traces (e.g., traces 110). Examples of some trace widths and spacings are provided in Table 1 below.

From the trace bundle design 725 at operation 720, a coil design 735 is generated at operation 730. That is, the bundle design 715 can be extended according to desired dimensions of a PCB coil to be manufactured and through a desired number of turns (also referred to as coil numbers) to provide a coil design 735. In an example implementation, the PCB coil may have dimensions of 150 mm×150 mm, 350 mm×350 mm, and the like.

From the coil design 735, a physical PCB coil 745 can be fabricated at operation 740. The PCB coil 745 can be fabricated using any PCB manufacturing techniques as known in the art.

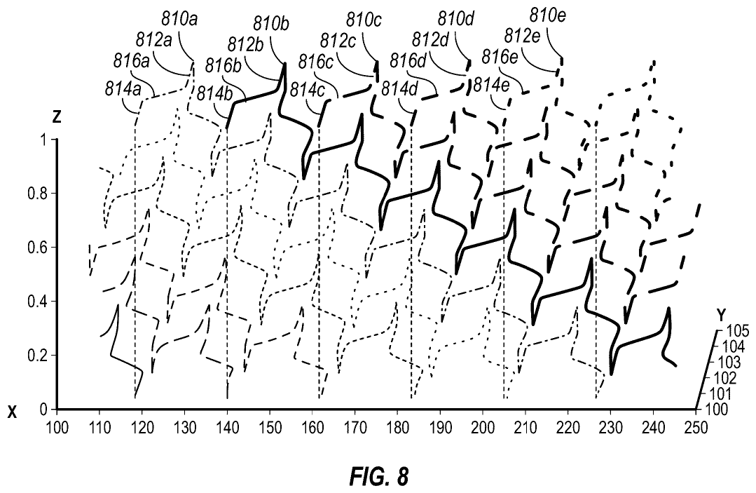

FIG. 8 is an example of a multi-route design 815 for multi-layer embodiment. Multi-route design 815 includes a plurality of individual route designs 810a-e generated, for example, at operation 710 of FIG. 7A. Each route design 810a-810e comprises segment designs 812a-e and 814a-e and connector designs 816a-e, respectively. In this example, each route design 810a-810e includes segment designs that are connected by connector designs through a single vertical space (e.g., corresponding to insulating layers). That is, for example, route design 810a includes segment design 812a is connected to segment design 814a by connector design 816a that steps through each insulating layer space in a sequential order, and thus the trace fabricated from route design 810a would be formed on each insulating layer of the resulting trace bundle.

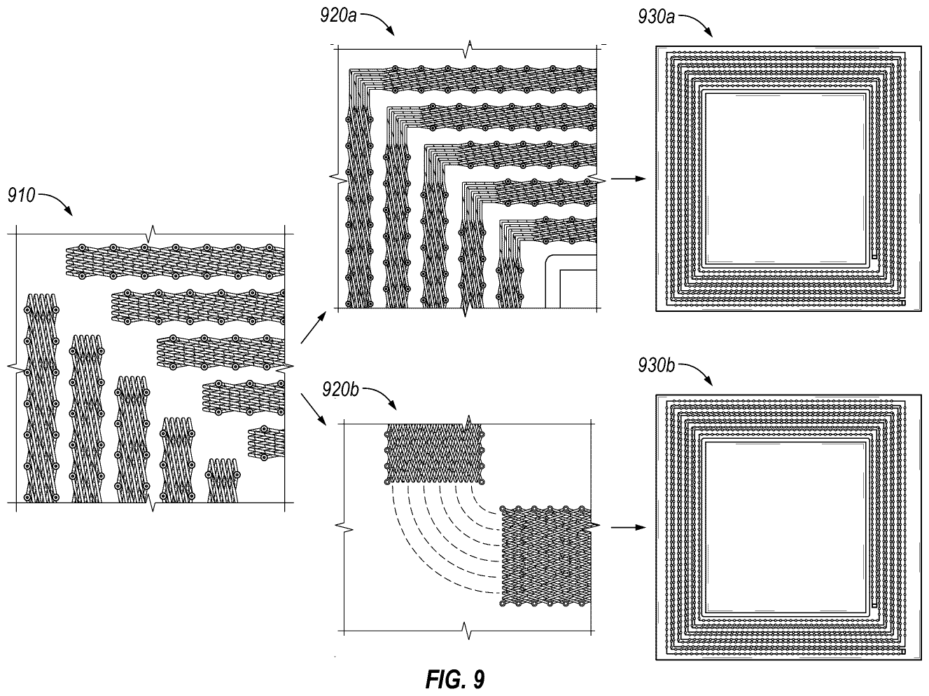

FIG. 9 illustrates example of corner connections in fabricating a PCB coil in accordance with embodiments of the present disclosure. Unconnected portions of a coil design 910 may be generated at operation 720. During operation 730, trace segments from one trace bundle 912 can be connected to another trace bundle 914 using, for example, a corner approach (e.g., right angle) as shown in design 920a, a rounded approach as shown in design 920b, or other desired connection methods. In either case, operation 730 results in a coil design, such as design 930a or 930b in a couple examples.

Table 1 below provides example of different PCB coils constructed according to the embodiments disclosed herein and experimental results on power transfer efficiency achieved by tuning design parameters between different designs. Table 1 below shows test results of inductance (L), AC resistance (Rac), DC resistance (Rdc), and quality (Q) factors for PCB coils of different boards organized by board number having different numbers of turns (e.g., coil numbers), conductor layers, thickness of conductive material of each layer (e.g., copper thickness in ounces), number of traces across a trace bundle (e.g., number of traces per a layer), total number traces in a trace bundle, trace width, and trace spacing. AC and DC resistance may reflect loss and the Q-factor can reflect the efficiency of power transfer.

TABLE 1

| Design parameters | | | | | | | | | | | |
|---|---|---|---|---|---|---|---|---|---|---|---|
| | | | | | | | Min | | | | |
| | | | Copper | | | | trace | Measured values | | | |
| Board | Coil | | thickness | Traces | # of | Trace | spacing/ | L | Rac | Rdc | Q |
| number | # | Layers | (oz) | across | traces | width | width | (uH) | (mΩ) | (mΩ) | measured |
| 1 | 1 | 4 | 2 | 15 | 59 | 0.2467 | 0.2 | 6.23 | 53.31 | 48.23 | 62.81 |
| 1 | 2 | 4 | 2 | 4 | 15 | 1.2947 | 0.2 | 6.32 | 85.18 | 37.02 | 39.63 |
| 1 | 3 | 4 | 2 | 7 | 27 | 0.7118 | 0.2 | 6.22 | 54.58 | 36.68 | 60.94 |
| 1 | 4 | 4 | 2 | 11 | 43 | 0.3997 | 0.2 | 6.17 | 43.56 | 33.94 | 75.61 |
| 2 | 5 | 4 | 4 | 10 | 39 | 0.3463 | 0.32 | 6.18 | 29.94 | 20.02 | 110.26 |
| 2 | 6 | 4 | 4 | 4 | 15 | 1.1989 | 0.32 | 6.45 | 78.09 | 5.65 | 44.16 |
| 2 | 7 | 4 | 4 | 6 | 23 | 0.745 | 0.32 | 6.08 | 50.25 | 23.74 | 64.66 |
| 2 | 8 | 4 | 4 | 8 | 31 | 0.4998 | 0.32 | 6.32 | 44.18 | 31.1 | 76.35 |
| 3 | 9 | 4 | 6 | 2 | 7 | 2.2377 | 0.45 | 5.84 | 82.88 | 5.34 | 37.6 |
| 3 | 10 | 4 | 6 | 4 | 15 | 1.0951 | 0.45 | 6.12 | 72.68 | 11.97 | 45.02 |
| 3 | 11 | 4 | 6 | 5 | 19 | 0.8237 | 0.45 | 5.89 | 45.34 | 5.87 | 69.43 |
| 3 | 12 | 4 | 6 | 7 | 27 | 0.4923 | 0.45 | 6.19 | 37.43 | 17.74 | 88.35 |
| 4 | 13 | 6 | 6 | 2 | 11 | 2.1308 | 0.45 | 5.98 | 96.98 | 3.59 | 32.94 |
| 4 | 14 | 6 | 6 | 4 | 23 | 1.0402 | 0.45 | 6.03 | 77.09 | 2.01 | 41.79 |
| 4 | 15 | 6 | 6 | 5 | 29 | 0.7792 | 0.45 | 6.05 | 52.48 | 2.46 | 61.67 |
| 4 | 16 | 6 | 6 | 7 | 41 | 0.4598 | 0.45 | 6.09 | 28.84 | 8.95 | 112.77 |
| 5 | 17 | 8 | 6 | 2 | 15 | 2.0551 | 0.45 | 5.72 | 106.77 | 5.06 | 28.62 |
| 5 | 18 | 8 | 6 | 4 | 31 | 0.99 | 0.45 | 5.81 | 81.88 | 4.59 | 37.88 |
| 5 | 19 | 8 | 6 | 5 | 39 | 0.736 | 0.45 | 5.94 | 60.06 | 5.99 | 52.85 |
| 5 | 20 | 8 | 6 | 6 | 47 | 0.5578 | 0.45 | 5.92 | 47.22 | 6.75 | 66.99 |

As can be seen from Table 1, AC resistance may be related to number of traces, width, and traces across. The thinner traces may lead to lower AC resistance because the thin trace acts similarly to Litz wire. The DC resistance may be affected by number of layers and thickness of copper. The lowest DC resistance occurred in PCB coils having 6 layers and 6-oz of copper.

Increases in amounts of copper may not necessarily be a key contributor to high Q-factors. For example, the highest Q-factor occurred in boards No. 4 and No. 2, but not in No. 5 which has more layers and more copper. A high-performance PCB coil should have a good balance of different structure permeants such as trace width, thickness, number of layers, etc. Generally, in order to achieve high Q, the loss may need to be minimized.

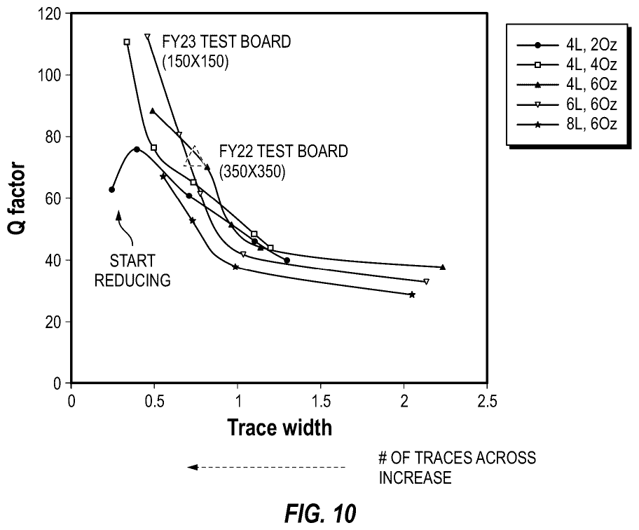

FIG. 10 shows changing trend of Q-factor for the PCB coils of Table 1. As can be seen in FIG. 10, as number of relatively traces increases, the Q-factor increases as well, but there may not be sufficient copper due to minimum gap widths between traces. Optimal design for high Q-factor performance could be achieved by selecting a balancing point between these competing parameters.

Based on the Table 1 and FIG. 10, an example candidate for an optimal PCB board for high power transfer applications (e.g., FIG. 11 below) may be a design having 6-layers with larger number of traces. Moving from 150 mm×150 mm size PCB coil to 350 mm×350 mm may increase the Q-factor result.

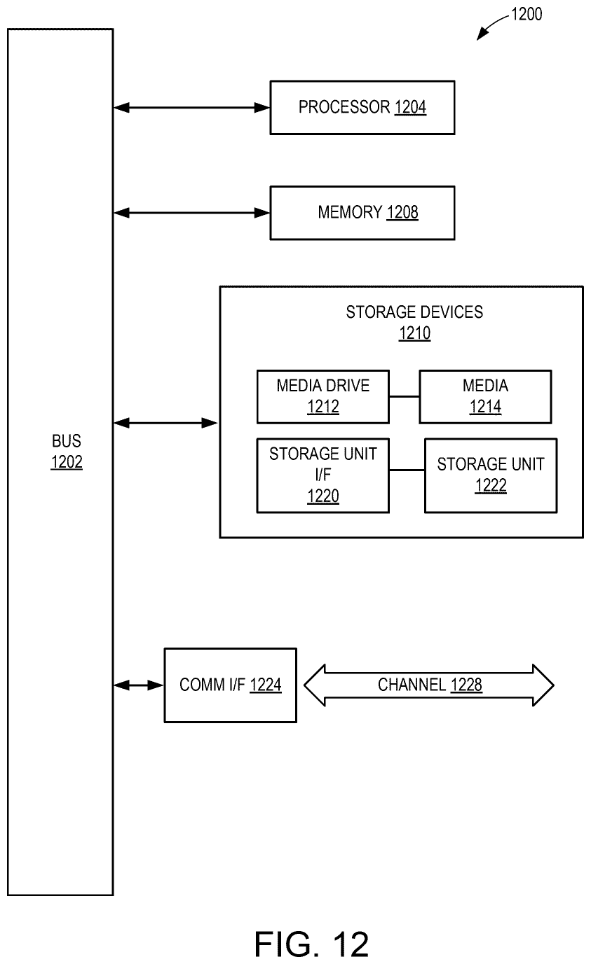

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 12. Various embodiments are described in terms of this example-computing component 1200. For example, computing component 1200 may be implemented to execute trace design system or portions thereof. After reading this description, it will become apparent to a person skilled in the relevant art how to implement the application using other computing components or architectures.

Referring now to FIG. 12, computing component 1200 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1200 might also represent computing capabilities embedded within or otherwise available to a given device. For example, a computing component might be found in other electronic devices such as, for example, portable computing devices, and other electronic devices that might include some form of processing capability.

Computing component 1200 might include, for example, one or more processors, controllers, control components, or other processing devices. This can include a processor, and/or any one or more of the components making up trace design system and/or wireless charging system 1100. Processor 1204 might be implemented using a general-purpose or special-purpose processing engine such as, for example, a microprocessor, controller, or other control logic. Processor 1204 may be connected to a bus 1202. However, any communication medium can be used to facilitate interaction with other components of computing component 1200 or to communicate externally.

Computing component 1200 might also include one or more memory components, simply referred to herein as main memory 1208. For example, random access memory (RAM) or other dynamic memory, might be used for storing information and instructions to be executed by processor 1204. Main memory 1208 might also be used for storing temporary variables or other intermediate information during execution of instructions to be executed by processor 1204. Computing component 1200 might likewise include a read only memory (“ROM”) or other static storage device coupled to bus 1202 for storing static information and instructions for processor 1204.

The computing component 1200 might also include one or more various forms of information storage mechanism 1210, which might include, for example, a media drive 1212 and a storage unit interface 1220. The media drive 1212 might include a drive or other mechanism to support fixed or removable storage media 1214. For example, a hard disk drive, a solid-state drive, a magnetic tape drive, an optical drive, a compact disc (CD) or digital video disc (DVD) drive (R or RW), or other removable or fixed media drive might be provided. Storage media 1214 might include, for example, a hard disk, an integrated circuit assembly, magnetic tape, cartridge, optical disk, a CD or DVD. Storage media 1214 may be any other fixed or removable medium that is read by, written to or accessed by media drive 1212. As these examples illustrate, the storage media 1214 can include a computer usable storage medium having stored therein computer software or data.

In alternative embodiments, information storage mechanism 1210 might include other similar instrumentalities for allowing computer programs or other instructions or data to be loaded into computing component 1200. Such instrumentalities might include, for example, a fixed or removable storage unit 1222 and an interface 1220. Examples of such storage units 1222 and interfaces 1220 can include a program cartridge and cartridge interface, a removable memory (for example, a flash memory or other removable memory component) and memory slot. Other examples may include a PCMCIA slot and card, and other fixed or removable storage units 1222 and interfaces 1220 that allow software and data to be transferred from storage unit 1222 to computing component 1200.

Computing component 1200 might also include a communications interface 1224. Communications interface 1224 might be used to allow software and data to be transferred between computing component 1200 and external devices. Examples of communications interface 1224 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1224 may be carried on signals, which can be electronic, electromagnetic (which includes optical) or other signals capable of being exchanged by a given communications interface 1224. These signals might be provided to communications interface 1224 via a channel 1228. Channel 1228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1208, storage unit 1222, media 1214, and channel 1228. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1200 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An electrical coil comprising:
at least one substrate;
a plurality of conductor layers, the conductor layers including a plurality of trace segments;
a plurality of interlayer connectors electrically interconnecting the plurality of trace segments of different conductor layers to define one or more traces that wind around the at least one substrate, each one or more traces having a density based on spacing between each trace segment of the plurality of trace segments; and
a coil formed of the one or more traces wound into a plurality of loops,
wherein the density of the one or more traces is varied across the plurality of loops of the coil.

2. The electrical coil of claim 1, wherein a first density of the one or more traces at a first location on the coil is larger than a second density of the one or more traces at a second location on the coil, wherein the first location is closer to a center of the coil than the second location.

3. The electrical coil of claim 1, wherein the density of the one or more traces is larger at higher current locations of the coil than lower current locations of the coil.

4. The electrical coil of claim 1, wherein the density of the one or more traces is based on a spacing between the plurality of interlayer connectors.

5. The electrical coil of claim 1, wherein the density of the one or more traces is based on a number of conductor layers comprised in the plurality of conductor layers.

6. The electrical coil of claim 1, wherein at least one trace segment of the plurality of trace segments of a given conductor layer extends in a single linear direction and parallel to the other trace segments of the given conductor layer.

7. The electrical coil of claim 1, wherein the at least one substrate comprises at least one insulating layers, wherein the plurality of interlayer connectors are disposed on an outer perimeter of the at least one insulating.

8. The electrical coil of claim 1, wherein the at least one substrate comprises a plurality of substrates, wherein a number of substrates is one less than a number of conductor layers.

9. The electrical coil of claim 1, wherein the plurality of interlayer connectors are through vias.

10. The electrical coil of claim 9, wherein the through vias a filled with a conductive material.

11. A wireless charging system, comprising:
an electrical coil comprising a coil having a plurality of turns of a trace bundle; and
the trace bundle comprising a plurality of traces formed from a plurality of trace segments electrically connected by a plurality of interlayer connectors, wherein each of the plurality of traces comprises a density of trace segments,
wherein the density of the plurality of traces is varied across the plurality of turns of the coil.

12. The wireless charging system of claim 11, wherein the electrical coil is part of at least one of a transmitter pad and a receiver pad.

13. The wireless charging system of claim 11, wherein a first density of the plurality of traces at a first turn of the coil is larger than a second density of the plurality of traces at a second turn of the coil, wherein the first turn is closer to a center of the coil than the second turn.

14. The wireless charging system of claim 11, wherein the density of the plurality of traces is based on a spacing between the plurality of interlayer connectors.

15. The wireless charging system of claim 11, wherein the plurality of interlayer connectors are through vias.

16. The wireless charging system of claim 15, wherein the through vias a filled with a conductive material.

17. The wireless charging system of claim 11, wherein at least one trace segment of the plurality of trace segments of a given trace of the plurality of traces extends in a linear direction and parallel to other trace segments of the given trace.

18. The wireless charging system of claim 11, wherein the plurality of traces comprises a common trace route that is repeated for the plurality of traces.

19. A method for fabricating an electrical coil, the method comprising:
generating at least one route design corresponding to a trace based on one or more design parameters;
repeating the at least one route design for a plurality of traces to form a trace bundle, wherein the plurality of traces are spaced based on a gap width included in the design parameters;
generating a coil design from the trace bundle; and
fabricating the electrical coil from the coil design.

20. The method of claim 19, further comprising varying the gap width across a plurality of loops of the coil.
